(19) United States
(12) Patent Application Publication
(10) Pub. No.: US 2011/0165319 A1
(43) Pub. Date: Jul. 7, 2011

(54) APPARATUS FOR FORMING SOLDER DAM AND METHOD OF FORMING SOLDER DAM

(75) Inventors: Masayuki KITAJIMA, Kawasaki-shi (JP); Yutaka NODA, Kawasaki-shi (JP); Hidehiko KOBAYASHI, Kawasaki-shi (JP); Toshihiro KUSAGAYA, Tokyo (JP); Kazuhiro MIZUKAMI, Tokyo (JP)

(73) Assignees: FUJITSU LIMITED, Kawasaki-shi (JP); FUJITSU COMPONENT LIMITED, Tokyo (JP)

(21) Appl. No.: 12/974,558

(22) Filed: Dec. 21, 2010

(30) Foreign Application Priority Data
Jan. 5, 2010 (JP) 2010-000695

(51) Int. Cl. B05D 5/00; B05C 1/00

(52) U.S. Cl. 427/58; 118/256

(57) ABSTRACT

An apparatus for forming a solder dam on a lead of an electronic component is disclosed. The apparatus for forming a solder dam includes a wire material that transfers an ink that prevents adhesion of a solder to the lead; a wire material conveying device that conveys the wire material along a surface of the lead; and an ink supply device that supplies the ink to the wire material.

### CROSS-REFERENCE TO RELATED APPLICATION

This application is based upon and claims the benefit of priority of the prior Japanese Patent Application No. 2010-000695, filed on Jan. 5, 2010, the entire contents of which are incorporated herein by reference.

### FIELD

The embodiments discussed herein are directed to a technique to form a solder dam on a lead of an electronic component.

### BACKGROUND

The reflow process is known as one of techniques for mounting electronic components on a printed board. In the reflow process, after placing electronic components on a substrate on which a pasteous solder has been applied or printed, the entire substrate is heated in an oven, known as a reflow oven, to cause melting of the solder, thereby soldering leads of the electronic components to predetermined locations on the substrate. The reflow oven has a far-infrared heater, a hot air heater, or the like, for example, incorporated therein, so that the solder on the substrate can uniformly melt.

The wettability of a molten solder (how easily the solder flows and spreads) varies, depending on the temperature at the location where the solder adheres. In the meantime, even if the temperature within the reflow oven is controlled to be uniform, the temperature of leads is sometimes increased beyond the temperature of lands on the substrate to which the heads are to be attached to, due to difference in the heat capacities of the substrate and the lead. In such as case, the molten solder on the substrate tends to move toward a resin package of an electronic component through the surface of a lead, the phenomenon generally being referred to as “solder wicking”, which may cause a contact failure between the lead and the land on the printed board.

To address this issue, a technique for preventing solder wicking by forming a solder resist layer on the surfaces of leads is known. In this technique, after leads are dipped into a liquid solder resist to a form resist layer film on the surfaces of leads, the resist layer at the tips of the leads is removed using a stripping solution to form solder contact portions. In other words, this technique attempts to prevent solder wicking by covering the leads with a resist layer, except for the tips of the leads.

In addition, another technique is known in which a solder-repellant resin is offset (transferred) to the middle portion of a lead to form solder dams. More specifically, a resin, such as a solder resist or silicone resin, is transferred to the lead by a pressing stamp to form solder dams in the form of a film (refer to Japanese Laid-open Patent Application No. H5-243327, for example).

However, the former technique may incur an increase in the manufacturing cost, since a resist layer is formed even at the locations where solder dams are undesirable and thus some portion of the resist layer needs to be removed, which is wasteful. In addition, since the remaining resist layer is left as solder dams, dimensional accuracy of the solder dams is affected by various factors, such as the viscosity of the solder resist, the concentration of the stripping solution, and how precise the stripping solution can be applied. This makes accurate and precise formation of minuscule solder dams difficult, rendering this technique unsuitable for fine-pitched leads.

On the other hand, the latter technique also has a difficulty in which the resin tends to aggregate on the surface of the lead since the resin is drawn away from the surface of the lead when the pressing stamp is displaced away from the lead, in combination with the surface tension action. As a result, the shapes of the resin transferred to the surface of the lead do not always match the shape of the pressing stamp, rendering the formation of solder dams having a desired width difficult.

### SUMMARY

Accordingly, the disclosed apparatus for forming a solder dam is an apparatus for forming a solder dam on a lead of an electronic component, the apparatus including: a wire material that transfers an ink that prevents adhesion of a solder to the lead of the electronic component; a wire material conveying device that conveys the wire material along a surface of the lead of the electronic component; and an ink supply device that supplies the ink to the wire material.

Furthermore, the disclosed method of forming a solder dam is a method of forming a solder dam on a lead of an electronic component, the method including: transferring a wire material along a direction in which the wire material extends; supplying, on the wire material, an ink that prevents adhesion of a solder; and transferring the ink supplied on the wire material to a surface of the lead.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is an overall perspective view of a semiconductor package manufactured by a solder dam formation apparatus according to one embodiment;

FIG. 1B is an enlarged perspective view of the main portion of the semiconductor package manufactured by the solder dam formation apparatus according to one embodiment;

FIG. 2A is a top view illustrating the entire construction of a solder dam formation apparatus according to one embodiment;

FIG. 2B is a side cross sectional view illustrating the entire construction of a solder dam formation apparatus according to one embodiment;

FIG. 3 is a schematic top view illustrating an enlarged view of the main portion of the solder dam formation apparatus in FIGS. 2A and 2B;

FIG. 4 is a perspective view illustrating transfer made by the solder dam formation apparatus in FIGS. 2A and 2B;

FIG. 5 is a perspective view illustrating a transfer failure in the solder dam formation apparatus in FIGS. 2A and 2B;

FIG. 6 is a process chart illustrating the operation of one embodiment;

FIG. 7A is a drawing illustrating an example of mount of a semiconductor package manufactured by the solder dam formation apparatus according to one embodiment, illustrating the example of surface mount;

FIG. 7B is a drawing illustrating an example of mount of a semiconductor package manufactured by the solder dam formation apparatus according to one embodiment, illustrating the example of through-hole mount;

FIG. 8 is a top view of a solder dam formation apparatus according to a variant; and

FIG. 9 is a perspective view of a lead frame used in a solder dam formation apparatus according to the variant.

### DESCRIPTION OF EMBODIMENT(S)

Hereinafter, embodiments of a solder dam formation apparatus and a method of forming a solder dam will be described with reference to the drawings. Note that the embodiments described below are described by way of example only, and various modifications and applications of techniques that are not provided explicitly in the following embodiments are not intended to be excluded. That is, the present embodiments can be practiced in various ways (by combining embodiments and variants, for example) without departing from the spirit thereof.

1. Overview of Solder Dam

A solder dam formation apparatus according to one embodiment is configured to form solder dams on a lead of an electronic component. Here, the term “solder dam” refers to a portion which is formed from a material which is resistant to adhesion of a solder (solder-repellant material) and serves to dam up the flow of the molten solder.

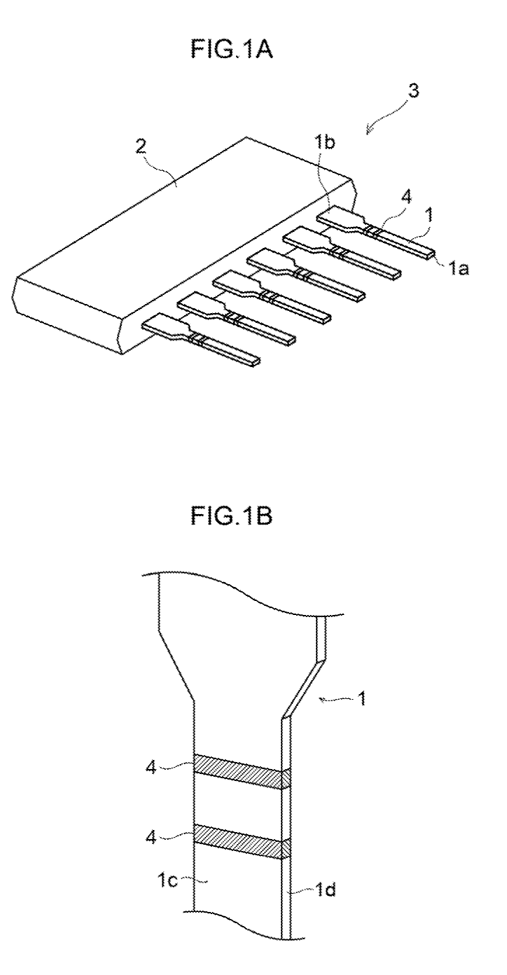

For example, as depicted in FIGS. 1A and 1B, looped solder dams 4 are formed on a lead 1 somewhere midway along the length of the lead 1 extending outwardly from a resin package 2 of a semiconductor package 3 (electronic component), such that the lead 1 is split into the tip end 1a side and the base end 1b side. The solder dams 4 can be regarded as surfaces for restricting physical displacement of the solder (wicking and creeping up of the solder from the tip end 1a side of the lead 1 toward the base end 1b side).

As depicted in FIG. 1B, the lead 1 is a plate member formed by die-cutting of a metal plate with a minuscule die (stamping).

Hereinafter, the surface portions will be referred to as “surfaces 1c”, whereas the cuts formed through the plate width (smaller surface area portions) will be referred to as “side cuts 1d”. The solder dams 4 are formed both on the surface 1c and both on the side cuts 1d.

Note that multiple solder dams 4 may be provided on the lead 1 in order to prevent solder wicking more effectively. For example, in the example illustrated in FIG. 1B, a pair of solder dams 4 are formed around the lead 1. In this case, even if some solder flows over the one solder dam on the tip end 1a side of the lead 1, the other solder dam 4 on the base end 1b side can prevent the solder from being wicked any further.

2. Construction of Apparatus

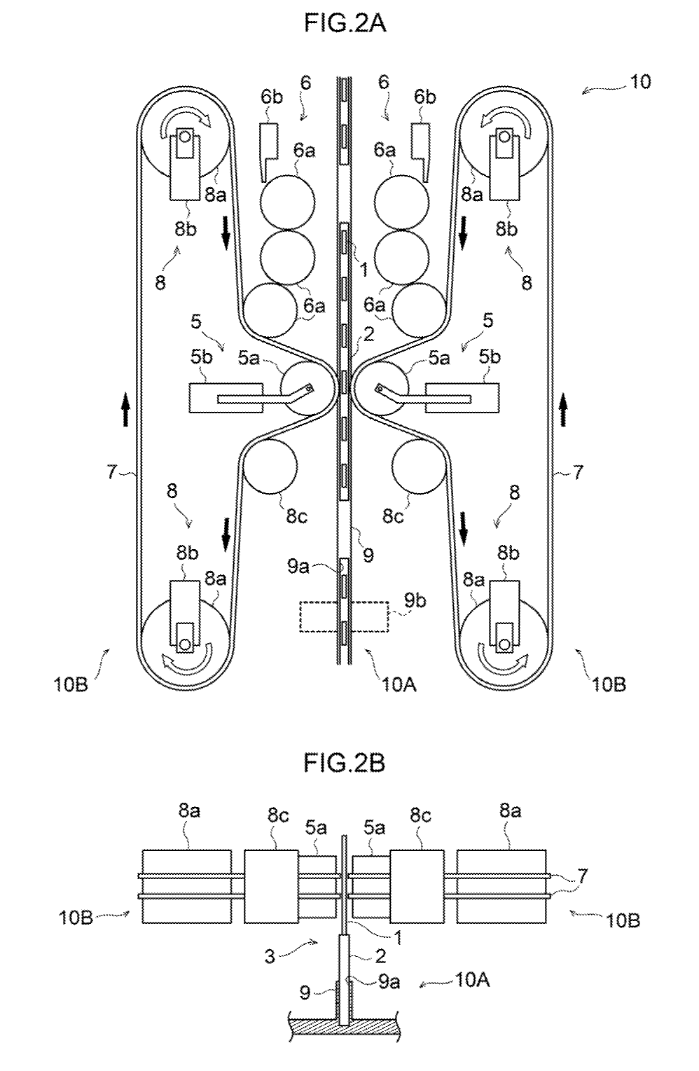

FIGS. 2A and 2B are diagrams illustrating one example of the construction of a solder dam formation apparatus 10. The solder dam formation apparatus 10 includes a lead conveying section 10A and wire driving sections 10B.

The lead conveying section 10A is configured to convey semiconductor packages 3 while holding the semiconductor packages 3, and includes a conveyor 9, for example. The conveyor 9 is provided with holding openings 9a in which resin packages 2 of semiconductor packages 3 are inserted, and a conveyor driving unit 9b that drives the conveyor 9. Once a resin package 2 is inserted into a holding opening 9a, the semiconductor package 3 is secured on the conveyor 9 such that leads 1 are vertically oriented upward. The semiconductor package 3 is conveyed along the direction in which the conveyor 9 extends, and solder dams 4 are formed on leads 1 while the semiconductor package 3 is being conveyed.

Each wire driving sections 10B is configured to form solder dams on the leads 1 of the semiconductor package 3 conveyed by the lead conveying section 10A, and includes a transfer mechanism 5 (pressing device), an ink supply mechanism 6 (ink supply device), a wire 7 (wire material), and a drive mechanism 8 (wire material conveying device). In FIG. 2A, the respective wire driving sections 10B are provided on the surfaces of the lead 1. In other words, the wire driving sections 10B are provided on each of the surfaces of the lead 1 in this example.

A drive mechanism 8 includes multiple driving pulleys 8a and a driven pulley 8c. As depicted in FIGS. 2A and 2B, the multiple driving pulleys 8a and the driven pulley 8c are all columnar rotating bodies. In this example, all of the rotation axes of the driving pulleys 8a and the driven pulley 8c are vertically oriented and plumb.

At least one of the multiple driving pulleys 8a is provided with a driving unit 8b. The driving unit 8b is configured to drive the corresponding driving pulley 8a to rotate it, and an electric motor or a prime mover is used as the driving unit 8b, for example. Note that, in the example in FIG. 2A, a driving unit 8b is provided for each of the driving pulleys 8a in order to stabilize the tensions and the conveyance speed of the wire 7. The outlined arrows in FIG. 2A each indicate the directions of the rotations of the driving pulleys 8a.

Each wire 7 is a looped member formed by connecting ends of a wire material made from a resin or a metal, and is wound around each of the driving pulleys 8a. The diameter (thickness) of the wire 7 can be to set to any suitable value, in accordance with the dam width of the solder dams 4 to be formed. Preferably, the diameter is set in a range from 0.1 mm to 1.0 mm.

In the case where a wire material made of a metal is used for the wire 7, preferably, a stainless steel wire, a piano wire (Japanese Industrial Standards (JIS) G3502 SWRS82A-K (steel product)), a hard drawn steel wire (JIS G3521), an oil hardened and tempered wire (JIS 3560), a brass wire, a nickel silver wire, a phosphor bronze wire, a beryllium copper wire, a titanium alloy wire (nickel-titanium alloy wire), a nickel alloy wire, a tungsten wire, and a molybdenum wire are used. These wires have excellent workability, as well as assuring sufficient stiffness, which are effective in reducing the wire diameter. Some types of alloys can enhance the corrosion resistance.

Alternatively, in the case where a wire material made of a resin is used, preferably, a nylon wire, a polyester wire, a biodegradable resin wire, a fluoro resin wire, an ABS (acrylonitrile butadiene styrene) resin wire, and a poly amide resin wire are used. These materials are inherently flexible, which is effective in improving the transfer property of the ink. In addition, the elasticity of the material can absorb a small dimension error caused by factors, such as the unsmoothness of the surface of a transfer target or the conveyance of the wires 7.

If two solder dam 4 are formed in parallel with each other, as depicted in FIG. 2B, upper and lower wires 7 are provided in an array along the direction of the rotation axis of the driving pulleys 8a. The number of wires 7 is appropriately set according to the number of solder dams 4 to be formed.

Each of the wires 7 is conveyed by means of rotations of the driving pulleys 8a along the direction in which the wire 7 extends, and travels along its orbit to the direction indicated by the black arrows. Each of the wires 7 preferably orbits on a single plane. Note that each driven pulley 8c provides the corresponding wire 7 with a certain tension by pressing the wire from the outside of its orbit in the direction perpendicular to the travel direction of the wire 7.

An ink supply mechanism 6 is a mechanism that supplies ink to the corresponding wire 7, and includes multiple ink supply rollers 6a and an ink supply nozzle 6b provided in an array outside the orbit of the wire 7. The ink supply nozzle 6b is configured to supply the ink that is the main component of solder dams 4 to the ink supply rollers 6a. The ink supplied from the ink supply nozzle 6b is transferred to the surface of each of the wires 7 after while being kneaded between the multiple ink supply rollers 6a.

The ink contains a material that prevents, after being dried, adhesion of a solder, i.e., a material that reduces the wettability of the solder. The ink also contains a material that exhibits heat resistance at the melting point of the solder. For example, a pigment, oil-based ink, and water-based ink containing a synthetic polymer resin, such as a silicone resin, an epoxy resin, a polyimide resin, as the main component, may be used.

Each transfer mechanism 5 is a mechanism that transfers the ink adhered on the wire 7 to a lead 1, and includes a transfer roller 5a and a pressing device 5b. The transfer mechanisms 5 are disposed in pair so as to put the lead 1 between the two surfaces thereof, as depicted in FIG. 2A. The transfer roller 5a is disposed inside the orbit of the wire 7 to convey the wire 7 along the surface 1c of the lead 1 of the semiconductor package 3 being conveyed by the conveyor 9.

In addition, the pressing device 5b is an actuator that has an expandable arm supporting the rotation axis of the transfer roller 5a. The pressing device 5b drives the transfer roller 5a in the direction perpendicular to the direction in which the lead 1 is conveyed, thereby setting and adjusting the distance of the gap between the lead 1 and the wire 7.

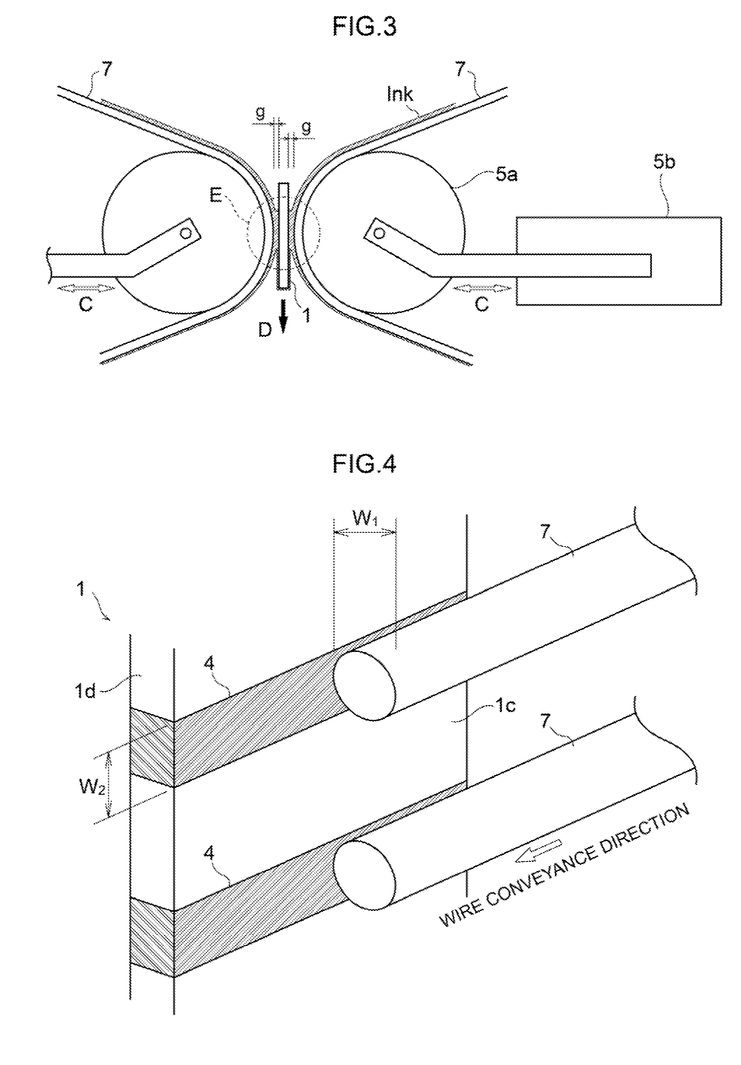

For example, as depicted in FIG. 3, the pressing device 5b drives the transfer roller 5a to the direction of Arrow C to place the transfer roller 5a in a certain position. Arrow D in FIG. 3 indicates the direction in which the lead 1 is conveyed. The minimum distance between the wire 7 wound on the surface of the transfer roller 5a and the lead 1 is the gap distance g. In this example, the transfer roller 5a is located such that the gap distance g becomes a certain value greater than zero (g>0).

In others words, the wires 7 do not contact the lead 1, and are positioned such that a certain gap is defined between the wires 7 and the lead 1. Accordingly, the wires 7 having the ink applied thereon are conveyed along the surface 1c of the lead 1 in the vicinity of the lead 1. In addition, the ink adhered on the wire 7 is transferred to the surfaces 1c and the side cuts 1d of the lead 1 via the gaps, thereby forming a solder dam 4 having a shape corresponding to the conveyance locus of the wires 7. As depicted in the circle of the broken line E in FIG. 3, the wires 7 travel in the direction parallel to the conveyance direction of the lead 1 while the ink is transferred to the lead 1.

The gap distance g is set to any suitable value, in accordance with various factors, such as the viscosity of the ink, the material of the surfaces 1c and the side cuts 1d of the lead 1, the conveyance speed of the wires 7, and the travel speed of lead 1 (i.e., the conveyance speed by the conveyor 9), for example. As depicted in FIG. 4, since the width W₂ of the ink transferred to the lead 1 (i.e., the desired dam width of solder dams 4 to be formed) varies with the diameter (thickness) W₁ of the wires 7 and the gap distance g, it is possible that the gap distance g is determined such that the diameter W₁ substantially matches the ink width W₂, for example.

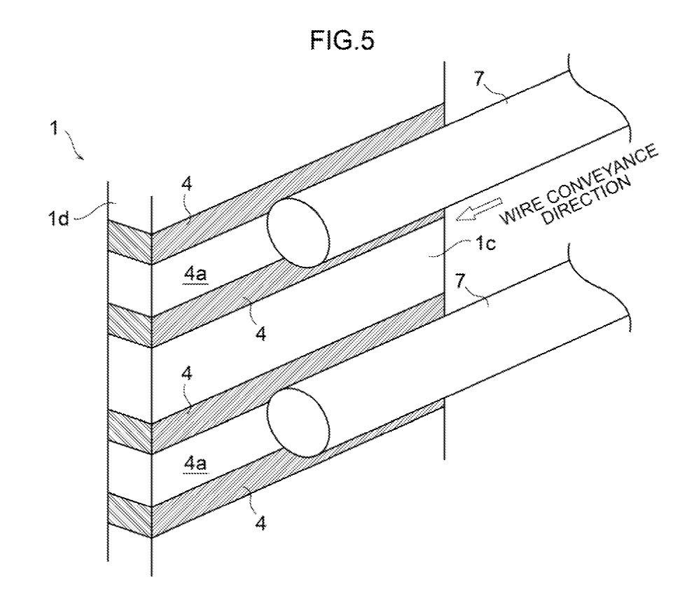

If the gap distance g is set to zero to make the wires 7 contact the lead 1, as depicted schematically in FIG. 5, the ink may be pushed from the portion with a greater contact pressure to the portion with a smaller contact pressure, which may results in an increased ink width W₂, as well as causing the faded portion 4a in the middle portion of the solder dam 4 with respect to the width direction of the solder dam 4. In contrast, with a certain gap distance g, it is possible to transfer the ink with an appropriate width W₂ and to prevent fading of the ink.

3. Process Chart

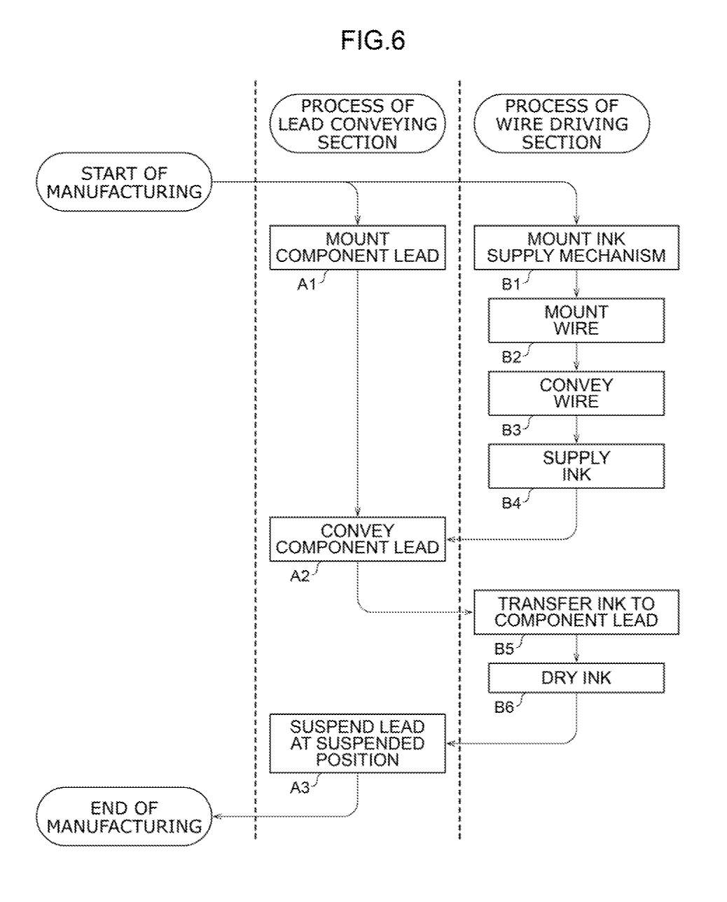

FIG. 6 is a process chart (production flow chart) illustrating one example of the control by a lead conveying section 10A and wire driving sections 10B. In this chart, controls in a single control cycle for forming solder dams 4 are arranged chronologically.

First, in the lead conveying section 10A, a semiconductor package 3 is inserted into a holding opening 9a of the conveyor 9 to set leads 1, which is targets to apply ink, to predetermined positions (Step A1). Simultaneously, in each wire driving section 10B, the ink supply rollers 6a are driven and the ink supply mechanism 6 is set (Step B1). As used herein, “set” means making a preparation.

Thereafter, each of the wires 7 are wound about the perimeters of the driving pulleys 8a and the transfer roller 5a such that the wire 7 makes contact with the ink supply roller 6a, and the driven pulleys 8c is pressed against the wire 7, thereby setting the wire 7 (Step B2). In this step, the wire 7 is provided with a certain tension. Note that a certain gap may be defined between the wire 7 and the ink supply roller 6a as long as the ink is transferred from the ink supply rollers 6a to the wire 7.

In addition, the position of the transfer roller 5a is changed by the pressing device 5b where necessary to adjust the gap distance g. In subsequent Step B3, the driving units 8b are activated to rotate the respective driving pulleys 8a, and the wires 7 are conveyed along the direction in which they extend (first step).

In further subsequent Step B4, ink is supplied from the ink supply nozzles 6b to the ink supply rollers 6a. After the ink is kneaded to be homogeneous across the ink supply rollers 6a, the ink is supplied to the wires 7 (second step). In the above-described steps, the wires 7 having the ink applied thereon travel on their respective orbits, thereby preparing for transfer.

After both of Steps A1 and B4 are completed, Step A2 is executed in the lead conveying section 10A, in which the conveyor driving unit 9b is operated to convey the lead 1. As a result, the semiconductor package 3 travels the conveyance route such that there is a gap distance g between the surface 1c of the lead 1 and the wires 7 wound about the transfer rollers 5a.

In subsequent Step B5, the wire driving section 10B, the ink adhered on the wires 7 is transferred to the surfaces 1c and the side cuts 1d of the lead 1 (third step). In this step, the lead 1 is conveyed to the direction of Arrow D while the lead 1 does not contact the wires 7, as depicted in FIG. 3. Accordingly, as depicted in FIG. 4, the ink is applied on the surfaces 1c and the side cuts 1d of the lead 1 to form a line having the ink width W₂, which is determined by diameter W₁ of the wires 7.

Thereafter, the lead 1 is further conveyed by the conveyor 9 to allow the ink transferred to the surfaces 1c and the side cuts 1d of the lead 1 to dry. Alternatively, the ink transferred to the lead 1 is forcefully dried with a dryer (Step B6). The dried and fixed ink is configured to function as the solder dams 4. When the lead 1 is conveyed to reach a predetermined position, the conveyor driving unit 9b is stopped and the semiconductor package 3 is removed from the holding opening 9a (Step A3). In the processes described above, the semiconductor package 3 having solder dams 4 formed on the leads 1 is manufactured.

4. Applications

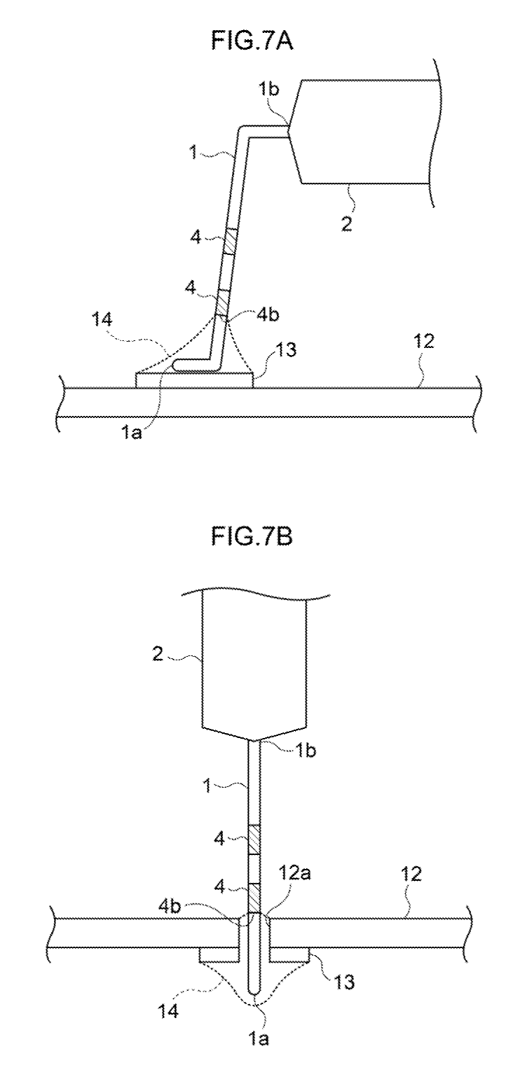

Examples of mount of a semiconductor package 3 having solder dams 4 formed by the above-described process are depicted in FIGS. 7A and 7B.

In the case of surface mount, as depicted in FIG. 7A, after the tip end 1a of a lead 1 that is bent at a substantially right angle is placed on a land 13 on a printed board 12, the tip end 1a is soldered to the land 13. During this process, even if the solder molten on the land 13 wicks up toward a resin package 2 along the surfaces 1c and side cuts 1d of the lead 1 due to a certain condition, such as the temperature, the solder is prevented from going beyond the solder dams 4 formed midway on this path since the solder dams 4 are solder-repellant.

Thereby, the solder is confined below the lower end 4b of the solder dam 4, and a solder fillet 14 having a desirable shape is formed, as depicted in the broken lines in FIG. 7A.

In the case of through-hole mount, as depicted in FIG. 7B, after a lead 1 is inserted through a through-hole 12a formed through a printed board 12 in the thickness direction, the tip end 1a of the lead 1 is soldered to a land 13 on a printed board 12. During this process, even if the solder goes through the through-hole 12a and wicks up toward a resin package 2 along the surfaces 1c and side cuts 1d of the lead 1 due to a certain condition, such as the temperature, the solder is prevented from going beyond the solder dams 4 formed somewhere midway on this path.

Accordingly, the solder is confined below the lower end 4b of the solder dam 4, and a solder fillet 14 having a desirable shape is formed, as depicted in the broken lines in FIG. 7B.

5. Effects

The effects achieved by one example of the above-described embodiment will be discussed.

### 5-1. Effects Obtained by Wire

By transferring ink to a lead 1 by means of wires 7, the precision of control of the solder dam width W₂ can be improved and minuscule solder dams 4 can be formed. For example, multiple solder dams 4 can be formed simultaneously with a smaller pitch. This technique can be also applied to fine-pitched leads 1 which are spaced apart with a very small pitch.

In addition, since the width of and the pitch between solder dams 4 are determined by the diameter and the arrangement of the wires 7, the precision of formation of the solder dams 4 can be significantly improved as the precisions of the diameter and arrangement of the wires 7 increases. When stainless-steel wires having a diameter of 0.2 mm were used as the wires 7, the precision of width W₂ of solder dams that were actually formed was 0.2+/−0.05 mm. In this manner, minuscule solder dams 4 can be easily formed with a very small formation error.

Note that wires 7 having a greater diameter provide wider solder dams 4, whereas wires 7 having a smaller diameter provide narrower solder dams 4. Accordingly, the diameter W₁ of wires 7 can be set to any desirable value, depending on the requirement on the width W₂ of solders dams 4. More preferably, the diameter of wire 7 is set in a range from 0.1 mm to 1.0 mm. Within this range, minuscule solder dams 4 can be formed while maintaining the strength and durability required for the wires 7.

The “transfer” of ink by the above-described solder dam formation apparatus 10 can be considered as drawing a line coinciding with the conveyance locus of the wires 7, rather than transferring a certain complex pattern. In other words, in accordance with the disclosed solder dam formation apparatus 10, the locations of the conveyance locus of the wires 7 can be made to precisely coincide with the locations to form solder dams 4, to draw linear solder dams 4 with a desired width.

In addition, since the wires 7 are conveyed toward the direction in which they extend, the travel locus of the wires 7 are made constant, thereby preventing any deviation in transfer of the ink. In other words, if the conveyance speed of the wires 7 is high as compared to the travel speed of the lead 1, lines are repeatedly drawn on the same location of the surface 1c of the lead 1 toward the direction in which the wires 7 extend. Thereby, the ink can be more reliably fixed on the surface 1c of the lead 1, and accordingly solder dams 4 can be more stably fixed. Note that the travel direction and the conveyance speed of leads 1, the conveyance direction and conveyance speed of the wires 7, and the like can be suitably set.

Furthermore, by supplying ink using looped wires 7 that are orbited, the ink can be supplied to leads 1 with a sequentially uniform amount. For example, it is possible to form solder dams 4 having uniform thicknesses can be formed on the surfaces 1c of leads 1.

### 5-2. Effects Obtained by Gap

The transfer rollers 5a are positioned such that a gap distance g becomes a certain value greater than zero (g>0) in the solder dam formation apparatus 10 disclosed above, and the wires 7 transfer ink to a lead 1 without contacting the lead 1. By defining the gap between the wires 7 and lead 1, fading of the ink and transfer failure can be prevented on the surface 1c and the side cuts 1d of the lead 1, thereby enabling formation of a sufficiently thick solder dams 4 possible.

In addition, since the wires 7 do not physically contact leads 1, wear of the wires 7 can be prevented and the lifetimes of components in the wire driving sections 10B can be increased. In addition to these, deformation and wear of leads 1 can be prevented, thereby assuring the quality of a semiconductor package 3.

Furthermore, since the transfer rollers 5a are supported on the respective pressing devices 5b for adjusting the gap distance g, the pressure applied by the ink on the surface 1c of a lead 1 (so-called printing pressure) can be adjusted, thereby adjusting the amount of the ink to be transferred. In other words, the thickness of solder dams 4 can be set to any suitable value.

6. Variants

Note that the present invention is not restricted to the embodiment described above, and various modifications may be made without departing from the spirit of the present embodiment. Constructions and processes of the present embodiment may be selected or suitably combined where necessary.

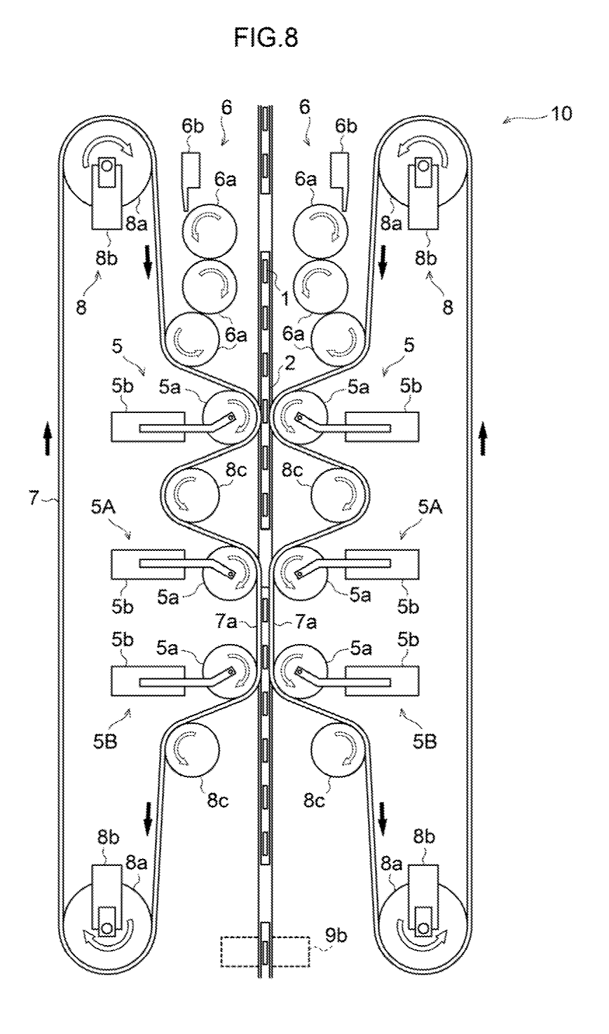

Although two transfer mechanisms 5 are disposed in pair on the left and right sides of a lead 1 along the travel direction of the lead 1 in the above-described embodiment, the number of transfer mechanisms 5 is not limited to two. For example, as depicted in FIG. 8, the multiple transfer mechanisms 5, 5A, and 5B may be provided in an array along the travel direction of leads 1. This enables additional overcoating of the ink, thereby further making solder dams 4 to be more reliably fixed.

It is also possible to make the wires 7 travel in parallel with the travel direction of leads 1 in some parts of the wires 7. For example, as depicted in FIG. 8, pairs of transfer mechanisms 5A and 5B may be disposed inside the conveyance loci of the wires 7 to form portions 7a of the wires 7 such that the portions 7a run in parallel with leads 1. Thereby, the time and frequency of contacts between the ink adhered on the wires 7 and the surfaces 1c of the leads 1 can be increased (i.e., the contact areas can be increased), thereby further making solder dams 4 to be more reliably fixed.

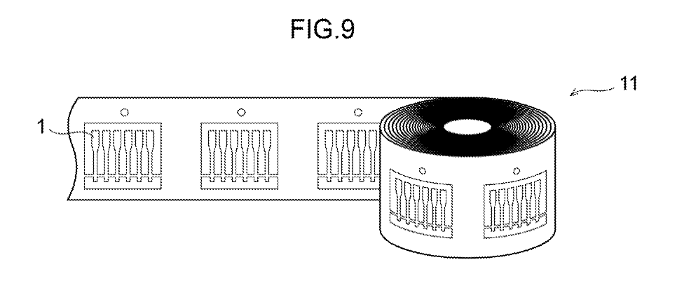

In addition, although the solder dam formation apparatuses 10 for forming solder dams 4 on a lead 1 of a semiconductor package 3 has been described in the embodiment describe above, solder dams 4 may be formed to other targets. For example, as depicted in FIG. 9, solder dams 4 may be formed on a strip lead frame 11 having multiple leads 1 before separated from a metal plate. In such a case, securing one end of a lead frame 11 to the conveyor 9 and conveying the lead frame 11 along the direction in which the conveyor 9 extends can provide the same effects as the above-described embodiment.

Note that, with regard to the embodiment and variants described above, various modifications may be made without departing from the spirit of the present embodiments. The embodiments may be practiced or manufactured by those ordinally skilled in the art with reference to the above disclosure.

In accordance with the technique described above, the precisions of the width of solder dams can be increased, as well as enabling formations of minuscule solder dams.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. An apparatus for forming a solder dam on a lead of an electronic component, the apparatus comprising:
a wire material that transfers an ink that prevents adhesion of a solder to the lead of the electronic component;
a wire material conveying device that conveys the wire material along a surface of the lead of the electronic component; and
an ink supply device that supplies the ink to the wire material.

2. The apparatus for forming a solder dam according to claim 1, wherein the wire material conveying device conveys the wire material toward a direction in which the wire material extends.

3. The apparatus for forming a solder dam according to claim 1, wherein the wire material transfers the ink to the lead of the electronic component without contacting the lead.

4. The apparatus for forming a solder dam according to claim 1, wherein the wire material is a wire that has a diameter corresponding to a width of the solder dam to be formed on the lead of the electronic component.

5. The apparatus for forming a solder dam according to claim 1, wherein the wire material is a wire that is made from a metal or a resin and has a diameter ranging from 0.1 mm to 1.0 mm.

6. The apparatus for forming a solder dam according to claim 1, further comprising a pressing device that presses the wire material towards the lead of the electronic component.

7. A method of forming a solder dam on a lead of an electronic component, the method comprising:
transferring a wire material along a direction in which the wire material extends;
supplying, on the wire material, an ink that prevents adhesion of a solder; and
transferring the ink supplied on the wire material to a surface of the lead.
